(19) United States
(12) Patent Application Publication
(10) Pub. No.: US 2018/0299475 A1
(43) Pub. Date: Oct. 18, 2018

(54) LIQUID DISPENSER

(71) Applicant: Bio-Rad Laboratories, Inc., Hercules, CA (US)

(72) Inventors: Yochanan Uri, Givat Ela (IL); Igor KOCHETKOV, Afula (IL); Shai AHARON, Yoqneam (IL); Itay BARAK, Haifa (IL); Uri ISSMAN, Haifa (IL)

(21) Appl. No.: 15/943,362

(22) Filed: Apr. 2, 2018

Related U.S. Application Data
(60) Provisional application No. 62/484,483, filed on Apr. 12, 2017.

(51) Int. Cl. G01N 35/10; G01N 1/18; G01N 1/14

(52) U.S. Cl. CPC G01N 35/1016; G01N 2035/1025; G01N 1/14; G01N 1/18

(57) ABSTRACT

Fraction collector dispensers and methods of using such dispensers are provided. In one embodiment, the dispenser includes an inlet for receiving liquid from a liquid source, wherein the inlet is in fluid communication with an outlet from which liquid is dispensed into a receptacle; and a reservoir in fluid communication with a flow path between the inlet and outlet, wherein the reservoir comprises trapped air therein and is configured to receive liquid during movement of the dispenser between receptacles or during movement of receptacles between dispense positions, wherein the dispenser is moveable between a first receptacle and a second receptacle or the receptacles are moveable between dispense positions.

This application claims the benefit of U.S. Provisional Application 62/484,483 filed on Apr. 12, 2017 which is hereby incorporated by reference in its entirety.

### BACKGROUND

Fraction collectors are commonly used to collect fractions of liquid from a liquid chromatography system. Fraction collectors collect fractions from a continuous stream of liquid by using a dispenser to dispense the liquid into a receptacle (e.g., a tube, a microwell, a vial, or a bottle). When a sufficient volume of liquid has been collected in the receptacle, either the dispenser is moved to the next receptacle or the next receptacle is moved into a dispense position. During transit of the dispenser or receptacles, liquid can be spilled between receptacles, resulting in loss of precious sample or resulting in contamination of adjacent receptacles and/or of fraction collector surfaces. Diverting liquid to waste during dispenser or receptacle transit can prevent spillage but can result in sample loss. Stopping the flow of liquid during dispenser or receptacle movement can result in backpressure that can damage components of the chromatography system.

### SUMMARY

Disclosed herein are dispensers for dispensing liquid, fraction collectors comprising these dispensers, and methods of using such dispensers.

In an embodiment, a dispenser includes an inlet for receiving liquid from a liquid source, wherein the inlet is in fluid communication with an outlet from which liquid is dispensed into a receptacle; a reservoir in fluid communication with a flow path between the inlet and outlet, wherein the reservoir comprises trapped air therein and is configured to receive liquid during movement of the dispenser between receptacles or during movement of receptacles between dispense positions, wherein the dispenser is moveable between a first receptacle and a second receptacle or the receptacles are moveable between dispense positions. In some embodiments, the reservoir is proximate to the outlet. In certain embodiments, the reservoir is a disposable pipette tip. In some embodiments, the reservoir is thermally insulated.

In certain embodiments, the dispenser further comprises a liquid sensor in the flow path between the reservoir and a pressurized air source. In some embodiments, the liquid sensor is an optical sensor comprising a light source directing light across a fluid flow path and an optical detector arranged to receive light.

In some embodiments, the dispenser further comprises a dispense valve (e.g., a 2-way valve) proximate to the outlet, wherein the dispense valve controls the flow of liquid dispensed by the dispenser.

In some embodiments, the dispenser further comprises a diverter (e.g., a 3-way valve) upstream of the dispenser. The diverter is configured to divert flow from a flow path to waste.

In certain embodiments, the dispenser further comprises an air valve (e.g., a 2-way valve) for controlling access from a pressurized air or gas source to the reservoir.

In an embodiment, a method comprises opening a dispense valve at the outlet of a dispenser to dispense liquid into a first receptacle, the dispenser comprising an inlet for receiving liquid from a liquid source, wherein the inlet is in fluid communication with an outlet from which liquid is dispensed into a receptacle; a reservoir in fluid communication with a flow path between the inlet and outlet, wherein the reservoir comprises trapped air therein and is configured to receive liquid during movement of the dispenser between receptacles or movement of the receptacles, wherein the dispenser is moveable between a first receptacle and a second receptacle or the receptacles are moveable between dispense positions; closing the dispense valve and an air valve between the reservoir and a pressurized air source before moving the dispenser to the second receptacle or before moving the second receptacle into a dispense position; filling the reservoir with liquid and compressing the trapped air in the reservoir while moving the dispenser to the second receptacle or while moving the second receptacle into the dispense position; and opening the dispense valve and pushing the liquid out of the reservoir with compressed air or gas after moving the dispenser to the second receptacle or after moving the second receptacle into the dispense position.

In some embodiments, the method further comprises opening an air valve and pushing a residual liquid out of the reservoir with pressurized air or gas while dispensing liquid. In certain embodiments, the method further comprises opening an air valve and pushing a residual liquid out of the reservoir with pressurized air or gas while dispensing liquid and when a fluid flow rate is increased. In some embodiments, a pressure of the pressurized air or gas ranges from 0.1 to 30 pounds per square inch or 0.1 to 10 pounds per square inch.

In some embodiments, the method further comprises stopping fluid flow when flow of liquid towards an air pressure source is detected with a liquid sensor (e.g., an optical liquid sensor) in the flow path between the reservoir and a pressurized air source.

In certain embodiments, a fraction collector includes any of the dispenser embodiments disclosed herein.

### BRIEF DESCRIPTION OF THE DRAWINGS

FIG. 1 is a schematic of a dispenser for use in a fraction collector according to an embodiment of the invention.

### DETAILED DESCRIPTION

Described herein are dispensers for use in fraction collectors and methods of using such dispensers. Dispensers and their methods of use have been discovered in which liquid is dispensed without spilling, spurting, or dropping liquid between fraction collector receptacles during dispenser or receptacle travel.

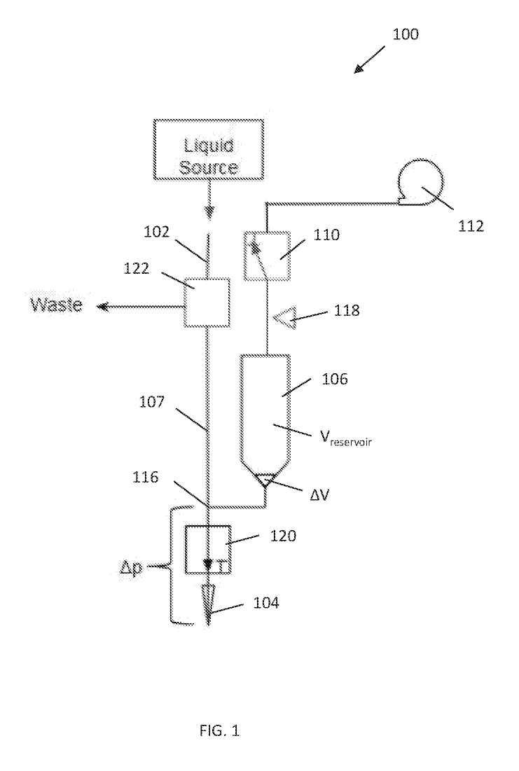

FIG. 1 illustrates an embodiment of a dispenser 100 for dispensing liquid. The dispenser 100 can be used in a fraction collector configured to collect fractions of liquid from a liquid source (e.g., a liquid chromatography system). For the dispenser 100, liquid is received by an inlet 102 in fluid communication with an outlet 104 from which the liquid is dispensed into a receptacle (e.g., a tube, a microwell, a vial, or a bottle). The dispenser 100 is moveable between a first receptacle and a second receptacle or the receptacles are moveable between dispense positions.

The dispenser 100 also includes a reservoir 106 in fluid communication with a flow path 107 between the inlet 102 and outlet 104. The reservoir 106 comprises trapped air therein and is configured to receive liquid during movement of the dispenser between receptacles or during movement of receptacles between dispense positions. The reservoir 106 is also configured to receive pressurized air or gas to empty liquid out of the reservoir 106 before or after movement of the dispenser or receptacles. In some embodiments, the reservoir 106 is proximate to the outlet 104.

In some embodiments, the reservoir 106 is a disposable pipette tip having sufficient internal volume to accommodate incoming sample volume while the dispenser or receptacles move. For example, the reservoir 106 can have an internal volume of about 0.1-2.0 milliliters (e.g., a desired length and internal diameter) to accommodate a flow rate up to and including 200 milliliters/minute and an accumulation time ranging from 0.1-3 seconds.

In some embodiments, the reservoir 106 is thermally insulated. Thermal insulation of the reservoir 106 reduces changes in temperature inside the reservoir, which reduces changes in the volume of trapped air or residual (unflushed) volume of liquid in the reservoir 106. The trapped air inside the reservoir 106 behaves as an ideal gas and complies with Boyle's Law. Also, the pressure in the reservoir 106 is constant as long as flow rate and viscosity are constant. If the temperature of the air trapped in the reservoir 106 decreases, the volume of the trapped air will decrease and more liquid will flow into the reservoir 106, thus increasing a residual volume of liquid in the reservoir. If, however, the temperature of the air trapped in the reservoir 106 increases, the volume of the trapped air will increase and excess air will expel into the flow path 107 until the system stabilizes. Both an increase in residual volume and expulsion of excess air into the flow path 107 can lead to bubble formation in the flow path 107 which is undesirable.

In some embodiments, an air valve 110 is located upstream from the reservoir 106 in the flow path of the pressurized air or gas. The air valve 110 controls access from a pressurized air or gas source 112 (e.g., a peristaltic or diaphragm pump) to the reservoir 106. For example, as illustrated in FIG. 1, the air/gas valve 110 is a 2-way valve that can connect the reservoir 106 to pressurized air/gas. In some embodiments, the pressurized air source 112 is an air tank with regulated pressure (e.g., by using a pressure sensor and a feedback loop). The air tank is fed by an air pump and the air valve 110 is placed between the air tank and the reservoir 106. The air pressure at the air tank is slightly higher than the back pressure of the liquid during dispensing so that the air will push the liquid down and out of the reservoir 106 instead of the liquid moving up into the reservoir 106.

The dispenser 100 further includes a T-junction 116 downstream of the reservoir 106. In some embodiments, the T-junction 116 is proximate to the outlet 104.

In certain embodiments, the dispenser 100 further comprises a liquid sensor 118 in the flow path between the reservoir 106 and the pressurized air source 112 to detect back flow of liquid toward the air pressure source 112. In some embodiments, the liquid sensor 118 is an optical sensor comprising a light source directing light across a fluid flow path and an optical detector arranged to receive light.

In some embodiments, the dispenser 100 further includes a dispense valve 120 proximate to the outlet 104. The dispense valve 120 is configured to control the flow of liquid dispensed by the dispenser 100. In some embodiments, the dispense valve 120 is a 2-way valve. In embodiments having a dispense valve 120 proximate to the outlet 104, the dispenser 100 can further include a pressure sensor to monitor backpressure at the liquid source.

In some embodiments, the dispenser 100 includes a diverter 122 configured to divert liquid flow from the flow path 107 to waste. In certain embodiments, the diverter 122 is located upstream of the dispenser 100. In some embodiments, the diverter 122 is a 3-way valve.

In operation of the dispenser 100, the dispense valve 120 located at the outlet 104 is opened and liquid is dispensed into a first receptacle. The dispense valve 120 and the air valve 110 are then closed before moving the dispenser 100 to a second receptacle or before moving the second receptacle into a dispense position. While moving the dispenser 100 to the second receptacle or while moving the second receptacle into a dispense position, the reservoir 106 in fluid communication with the flow path 107 between the inlet 102 and outlet 104 is filled and air in the reservoir is compressed by liquid accumulating in the reservoir 106. After moving the dispenser 100 or the second receptacle, the dispense valve 120 is opened and liquid is pushed out of the reservoir 106 with compressed air.

While liquid is dispensed, fluid back pressure (Δp) at the T-junction 116 increases above atmospheric pressure and a volume of liquid (ΔV), referred to as “unswept volume”, “residual liquid” or “unflushed liquid”, flows into the reservoir 106, compressing the trapped air inside the reservoir until air pressure inside the reservoir equalizes with fluid pressure and the system reaches steady state. The volume of residual liquid can be defined by the following equation:

$$Δ V = {V}_{reservoir} * ( 1 - \frac{{P}_{reservoir}}{{P}_{reservoir} + Δ p} ) \qquad ( 1 )$$

where ΔV is residual liquid;

Vᵣₑₛₑᵣᵥₒᵢᵣ is the reservoir volume;

Pₐₜₘₒₛₚₕₑᵣₑ is the initial air pressure in the reservoir before the onset of fluid flow (i.e., the atmospheric pressure); and

Δp is the back pressure at the T-junction.

In some embodiments in which residual liquid is in the reservoir 106, the method further comprises pushing the residual liquid out of the reservoir 106 with pressurized air or gas while dispensing liquid and without increasing the flow rate or fluid viscosity. Residual liquid will be pushed out of the reservoir 106 if the air pressure is higher than the liquid back pressure at the T-junction. In certain embodiments, when a fluid flow rate is increased, the method further comprises pushing a residual liquid out of the reservoir with pressurized air or gas while dispensing liquid. In embodiments using pressurized air or gas to push liquid out of the reservoir 106, the pressure of the air or gas ranges from about 0.1 to 30 pounds per square inch or from about 0.1 to 10 pounds per square inch. The duration of the air pulse depends on the air pressure, liquid flow rate and the volume of liquid to be flushed out of the reservoir. In some embodiments, the duration of the air pulse ranges from about 10 milliseconds to about 5 seconds. In certain embodiments, the duration of the air pulse ranges from about 100 milliseconds to about 1 second.

In some embodiments, the method further comprises stopping fluid flow when flow of liquid towards an air pressure source 112 is detected with a liquid sensor 118 (e.g., an optical liquid sensor) in the flow path between the reservoir 106 and a pressurized air source.

Dispenser embodiments can be operably connected to a liquid chromatography system (i.e. the liquid source) that includes control circuitry configured to control the operation of the fraction collector and dispenser along with other components of the system.

All patents, patent applications, and other published reference materials cited in this specification are hereby incorporated herein by reference in their entirety. As used in this specification and the appended claims, the singular forms “a”, “an”, and “the” include plural referents unless the content clearly dictates otherwise.

What is claimed is:

1. A dispenser comprising:
an inlet for receiving liquid from a liquid source, wherein the inlet is in fluid communication with an outlet from which liquid is dispensed into a receptacle; and
a reservoir in fluid communication with a flow path between the inlet and outlet, wherein the reservoir comprises trapped air therein and is configured to receive liquid during movement of the dispenser between receptacles or during movement of receptacles between dispense positions,
wherein the dispenser is moveable between a first receptacle and a second receptacle or the receptacles are moveable between dispense positions.

2. The dispenser of claim 1, further comprising a liquid sensor in the flow path between the reservoir and a pressurized air source.

3. The dispenser of claim 2, wherein the liquid sensor comprises an optical liquid sensor.

4. The dispenser of claim 3, wherein the optical liquid sensor comprises a light source directing light across a fluid flow path and an optical detector arranged to receive light.

5. The dispenser of claim 1, further comprising a diverter to divert liquid to the outlet or to waste.

6. The dispenser of claim 5, wherein the diver ter is a 3-way valve.

7. The dispenser of claim 1, wherein the reservoir is proximate to the outlet.

8. The dispenser of claim 1, further comprising an air valve for controlling access from a pressurized air or gas source to the reservoir.

9. The dispenser of claim 8, wherein the air valve is a 2-way valve.

10. The dispenser of claim 8, wherein a pressure of the pressurized air or gas ranges from 0.1 to 30 pounds per square inch.

11. The dispenser of claim 1, further comprising a dispense valve proximate to the outlet, wherein the dispense valve controls the flow of liquid dispensed by the dispenser.

12. The dispenser of claim 11, wherein the dispense valve is a 2-way valve.

13. The dispenser of claim 1, wherein the reservoir is a disposable pipette tip.

14. The dispenser of claim 1, wherein the reservoir is thermally insulated.

15. A fraction collector comprising the dispenser of claim 1.

16. A method comprising:
opening a dispense valve at the outlet of a dispenser to dispense liquid into a first receptacle, the dispenser comprising:
an inlet for receiving liquid from a liquid source, wherein the inlet is in fluid communication with an outlet from which liquid is dispensed into a receptacle;
a reservoir in fluid communication with a flow path between the inlet and outlet, wherein the reservoir comprises trapped air therein and is configured to receive liquid during movement of the dispenser between receptacles or movement of the receptacles,
wherein the dispenser is moveable between a first receptacle and a second receptacle or the receptacles are moveable between dispense positions
closing the dispense valve and an air valve between the reservoir and a pressurized air source before moving the dispenser to the second receptacle or before moving the second receptacle into a dispense position;
filling the reservoir with liquid and compressing the trapped air in the reservoir while moving the dispenser to the second receptacle or while moving the second receptacle into the dispense position; and
opening the dispense valve and pushing the liquid out of the reservoir with the compressed air or gas in the reservoir after moving the dispenser to the second receptacle or after moving the second receptacle into the dispense position.

17. The method of claim 16, further comprising pushing a residual liquid out of the reservoir with pressurized air or gas while dispensing liquid.

18. The method of claim 16, further comprising pushing a residual liquid out of the reservoir with pressurized air or gas while dispensing liquid and when a fluid flow rate is increased.

19. The method of claim 17, wherein a pressure of the pressurized air or gas ranges from 0.1 to 30 pounds per square inch.

20. The method of claim 16, further comprising stopping fluid flow when flow of liquid towards an air pressure source is detected with a liquid sensor in the flow path between the reservoir and the pressurized air source.
